(19) United States
(12) Patent Application Publication
(10) Pub. No.: US 2012/0233576 A1
(43) Pub. Date: Sep. 13, 2012

(54) SCHEMATIC-BASED LAYOUT MIGRATION

(75) Inventors: Geoffrey R. Barrows, Rochester, MN (US); Derick G. Behrends, Rochester, NM (US); William J. Craig, South Burlington, VT (US); Michael S. Gray, Fairfax, VT (US); Matthew T. Guzowski, Essex Junction, VT (US); Kevin W. McCullen, Essex Junction, VT (US); Rani Narayan, San Jose, CA (US); Robert F. Walker, St. George, VT (US)

(73) Assignee: International Business Machines Corporation, Armonk, NY (US)

(21) Appl. No.: 13/043,761

(22) Filed: Mar. 9, 2011

(51) Int. Cl. G06F 17/50

(52) U.S. Cl. 716/103

(57) ABSTRACT

Method, system, computer, etc., embodiments receive an original integrated circuit design into a computerized device. The methods herein automatically replace at least some of the original cells within the original integrated circuit design with replacement cells using the computerized device. Each of the replacement cells has an initial cell size that is unassociated with any specific design size. The methods herein automatically change the original design size of the integrated circuit design to a changed design size, and automatically individually change the initial cell size of each of the replacement cells to different sizes. At least two different replacement cells are changed from the initial cell size by different size reduction amounts based on different amounts of space required within the changed design size for each of the replacement cells.

### BACKGROUND

The present invention relates to integrated circuit design, and more specifically, to methods, systems, and computers that migrate layouts within integrated circuit designs that provides target leaf level cells with unique, personalized scaling ratios.

Semiconductor designs can typically be divided into two broad categories, analog or digital. Digital layouts can be very large, have a high density, and have nearly uniform scaling (which is ground rule driven and/or pitch driven). To the contrary, analog layouts are generally smaller, have a low to medium density, and have highly variable scaling (that may be driven by power requirements, voltage scaling requirements, or intrinsic device performance).

When migrating a digital design, the device sizes typically scale uniformly (or nearly so), enabling the layout migration to proceed independently of the schematic migration.

Analog migrations present automation challenges because there is typically not a “uniform”, “predictable” or “consistent” scaling ratio applied across the design. Varying amounts of uneven scaling always occur, and in fact they drive much of the need for cleanup post scaling (after all, if everything scaled evenly there would not be very many errors left.) Further, customers typically make manual changes to the device sizes in analog migrations. This requires a physical to schematic match. It is necessary to take the changes to the schematic into account when migrating the layout by measuring the actual scaling or each device.

### SUMMARY

Various embodiments herein receive an original integrated circuit design into a computerized device. The original integrated circuit design has an original design size and comprises a plurality of original cells. The methods herein automatically replace at least some of the original cells within the original integrated circuit design with replacement cells using the computerized device. Both the original and replacement cells are typically instantiated from separate libraries of predefined functions, called Process Design Kits (PDK). Many of the cells in the PDK will be PCells (http://en.wikipedia.org/wiki/PCell). Each PCell has a set of parameters that define the actual implementation of the cell. For example, two instances of a particular PCell could be placed, such that each instance has difference parameters. Each instance would have the same basic function, but they would have different performance and difference sizes. Each of the replacement cells has an initial cell size that is not necessarily associated with a specific design size. The methods herein automatically change (increase or decrease) the original design size of the integrated circuit design to a changed design size, and automatically individually change the initial cell size of each of the replacement cells to different sizes. At least two different replacement cells are changed from the initial cell size by different size reduction amounts based on different amounts of space required within the changed design size for each of the replacement cells.

Other methods receive an original integrated circuit design associated with an original technology into a computerized device. Again, the original integrated circuit design has an original design size and comprises a plurality of original cells. Also, each of the original cells comprises an individual grouping of integrated circuit devices performing a function. The methods herein automatically replace at least some of the original cells with replacement cells within the original integrated circuit design to migrate the integrated circuit design to a different technology using the computerized device. The replacement cells have corresponding functions to the original cells that the replacement cells replace. Further, each of the replacement cells has an initial cell size that is unassociated with any specific design size. The methods herein automatically change the original design size of the integrated circuit design to a changed design size, again using the computerized device. The methods herein further automatically individually change the initial cell size of each of the replacement cells to different sizes to produce a migrated circuit design (using the computerized device). At least two different replacement cells are changed from the initial cell size by different size reduction amounts based on different amounts of space required within the changed design size for each of the replacement cells. The methods herein automatically output the migrated circuit design from the computerized device.

Computer storage device embodiments herein comprise a non-transitory, computer-readable storage medium storing instructions executable by a computer to perform methods that receive an original integrated circuit design into a computerized device. The original integrated circuit design has an original design size and comprises a plurality of original cells. The methods herein automatically replace at least some of the original cells within the original integrated circuit design with replacement cells using the computerized device. Each of the replacement cells has an initial cell size that is unassociated with any specific design size. The methods herein automatically change the original design size of the integrated circuit design to a changed design size, and automatically individually change the initial cell size of each of the replacement cells to different sizes. At least two different replacement cells are changed from the initial cell size by different size reduction amounts based on different amounts of space required within the changed design size for each of the replacement cells.

### BRIEF DESCRIPTION OF THE SEVERAL VIEWS OF THE DRAWINGS

The embodiments of the invention will be better understood from the following detailed description with reference to the drawings, which are not necessarily drawing to scale and in which:

FIG. 1 is a schematic diagram of an exemplary user interface screen that can be used with embodiments herein;

FIG. 2 is a schematic diagram of an exemplary user interface screen that can be used with embodiments herein;

FIG. 3 is a flow diagram illustrating embodiments herein;

FIG. 4 is a schematic diagram of a hardware system according to embodiments herein;

FIG. 5 is a schematic diagram of a deployment system according to embodiments herein;

FIG. 6 is a schematic diagram of an integration system according to embodiments herein;

FIG. 7 is a schematic diagram of an on demand system according to embodiments herein; and

FIG. 8 is a schematic diagram of a virtual private network system according to embodiments herein.

### DETAILED DESCRIPTION

As mentioned above, the embodiments herein provide a method of performing technology migration (aka process migration) when the scaling of leaf level cells cannot be predicted. In this method, the embodiments herein first replace all of the leaf level cells with the target cells (technology and parameters, such as gate sizes or resistor size), measure the actual target cells, and then return to the source technology and scale the layout so that the target cells will fit. In effect, each leaf level cell has a unique, personalized scaling ratio.

The embodiments herein provide schematic-driven scaling (also called dual-scaling, or adaptive-scaling). They test fit the leaf cells and adjust the layout to the actual scaling, rather than knowing a priori how each element will scale. Further, the embodiments herein revise cell types dynamically and can reset the cell type to match the schematic (i.e. channel length changes, oxide thickness changes, capacitor type changes).

Stripping power busses and wires from the layout is performed before scaling and adding new buses and wires is performed after scaling because wire connections constrain (and sometimes prevent) variable scaling. Further, electromigration and parasitic changes between technologies make “constant” wire width scaling difficult. Power (and ground) busses are typically stripped by selecting all shapes owned by nets with predefined net names.

Exemplary methods of stripping wires include, but are not limited to, removing the last segment of a wire that connects to a cell, removing all portions of a wire that cross the boundary of a cell (or a pre-defined “keep-out” region around the cell), or removing all of the wires in the layout. Removal of some or all of the connectivity allows the pins within the cells to move freely between the source and target technology. When removing the wiring, the connectivity information (for example, net names, pin numbers, and what cells are connected) is preserved in order to facilitate rewiring the layout after scaling.

An additional feature of embodiments herein is automatic cell origin adjustment. The embodiments herein measure the cell origin in relation to the cell bounding box and move cell locations to keep the bounding boxes consistent between source and target. Some cell libraries define origins differently. For example, the source technology may define the cell origin at the lower left hand corner of the first finger, while the target may use the lower left hand corner of the diffusion. Similarly, the embodiments herein change the cell parameters dynamically and set cell parameters (like FET configuration) to match the actual layout usage. For example, including dummy PC or other lithography assist features for isolated devices or removing these features for nested devices.

The embodiments herein keep vertically abutting cells (given a horizontal gate orientation) aligned during differential scaling and allow adjacent cell columns to “slide” past each other while maintaining cell abutments along the horizontal edges. This keeps adjacent items aligned if edges are coincident (i.e., cells have the same start/end coordinates).

This methodology migrates layouts where the schematic is automatically migrated or is manually migrated. The embodiments herein no longer require strictly uniform scaling of leaf level cells. The embodiments herein therefore migrate one technology's leaf cell placements to create a newer technology “router-ready” custom macro layout.

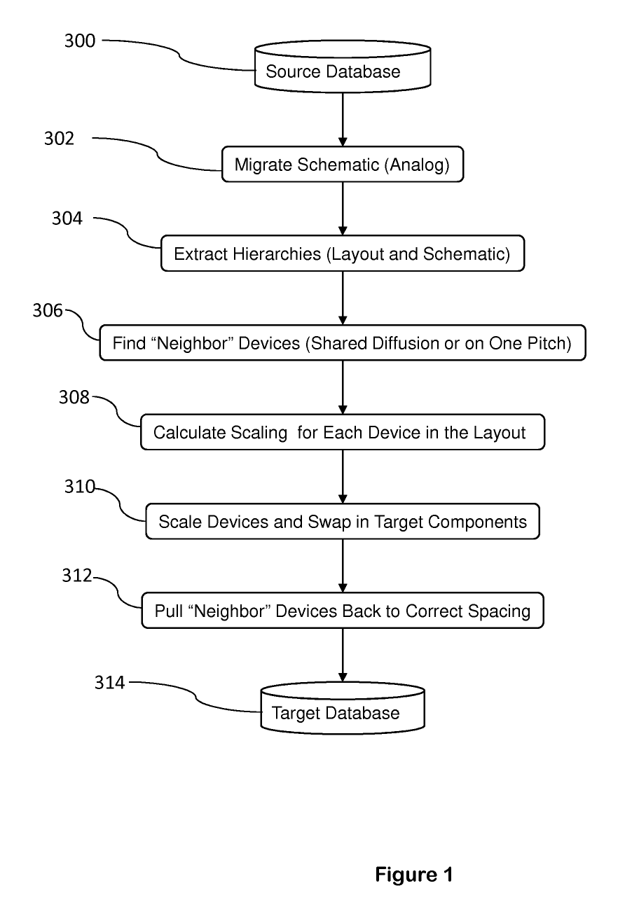

For example, as shown in FIG. 1, one source technology is migrated into a target technology. Both layouts are typically stored in a design database such as OpenAccess (reference OpenAccess API, Cadence Inc., located in Bellingham, Wash., USA, http://en.wikipedia.org/wiki/OpenAccess). Item 300 in FIG. 1 is a database of the first technology. In item 302, a circuit design from this first technology is subjected to analog migration. Following this, in item 304, the layout and schematic hierarchies are extracted for the analog migration process. Using these hierarchies, neighboring devices are identified in item 306. These neighboring devices can share a diffusion area or be one pitch distance measure away from each other, etc.

In item 308, the scaling for each of the devices in the layout can be calculated and in item 310, the newer technology components (from the target technology PDK) are substituted into the older technology design and such devices are scaled individually (independently). In item 312, the various neighbor devices are pulled back to correct any improper spacing and the resulting migrated circuit design is stored in the newer design database 314.

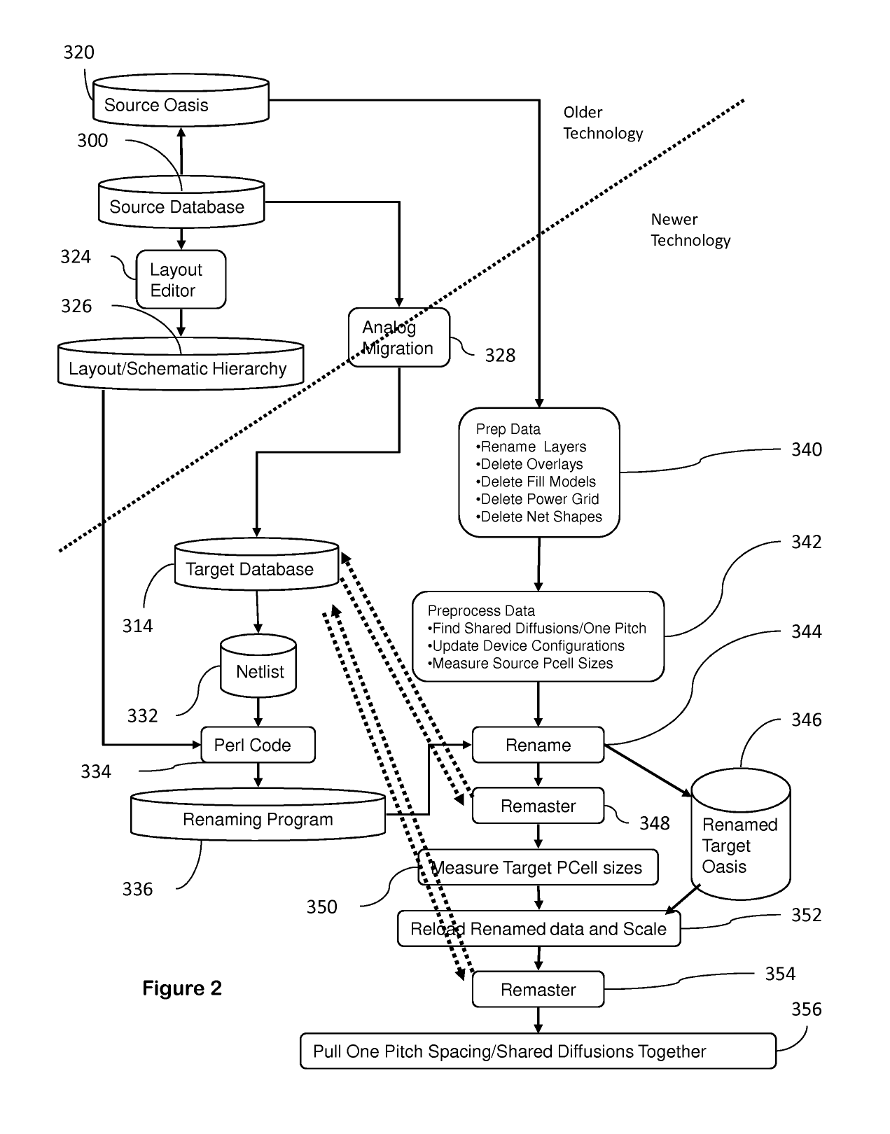

FIG. 2 also illustrates this processing as items are migrated from an older technology in the upper left-hand corner of FIG. 2 to a newer technology in the lower right-hand corner of FIG. 2. More specifically, item 320 represents a source input file, such as the Open Artwork System Interchange Standard format (http://en.wikipedia.org/wiki/OASIS_Open_Artwork_System_Interchange_Standard) or GDS II format (http://en.wikipedia.org/wiki/GDS_II) and items 300 again represents the older technology database. Item 324 is an interactive graphics program which produces the layout/schematic hierarchy 326. A unit for performing the analog migration process mentioned above is shown in item 328 and the newer technology database is again shown as item 314.

From the database 314, various netlists 332 are produced and these are combined by a Perl (http://en.wikipedia.org/wiki/Perl) program 334 to dynamically create a renaming program 336. Perl program 334 matches the source netlist cells to target netlist cells, and creates a program 336 that specifies, for each physical cell, the target cell and target cell parameters (i.e. size, device type, etc). Item 340 represents a data preparation unit for preparing the source data 320. This unit 340 can perform many different functions such as renaming layers, deleting overlays, deleting fill cells, deleting power grids, deleting net shapes, etc.

Item 342 represents a data preprocessing unit that is used to find neighboring cells (ones that share diffusions, or are one pitch away from each other); update various configuration data (such as parameters that specify the number of device contacts or the number and type of lithography assist features included in the cell); measure the cell sizes; etc. Item 344 represents a renaming unit that, in conjunction with the remastering code 336, renames the various cells that are replaced to migrate to the newer technology. Item 344 applies such renaming information and produces the renamed Oasis 346.

Using the information from the renaming module 344, remastering is performed 348. Remastering is the process of executing the PCell functions in the PDK that create a shape representation for each cell in the database 314. The measurement unit 350 measures the cell sizes of the newly updated cells and item 352 represents a unit that reloads the renamed data and scales the new devices using information from the renamed oasis 346.

Measurement unit 350 may use one of a number of different methods to calculate the size of a cell. For example, the size of a cell may be defined as the number of poly pitches (how many gates tall, for example), or the outline (bounding box) of the cell, as defined by any particular combination of levels. For example, the bounding box on the wiring layer may be used to calculate the size of one type of cell (for example, a Capacitor), while the number of poly pitches may be used to calculate the size of another type of cell (for example, a FET).

Item 354 presents an additional remastering unit that once again performs a remastering process and similarly updates the database 314. Item 356 represents a spacing adjustment unit that pulls neighboring cells together.

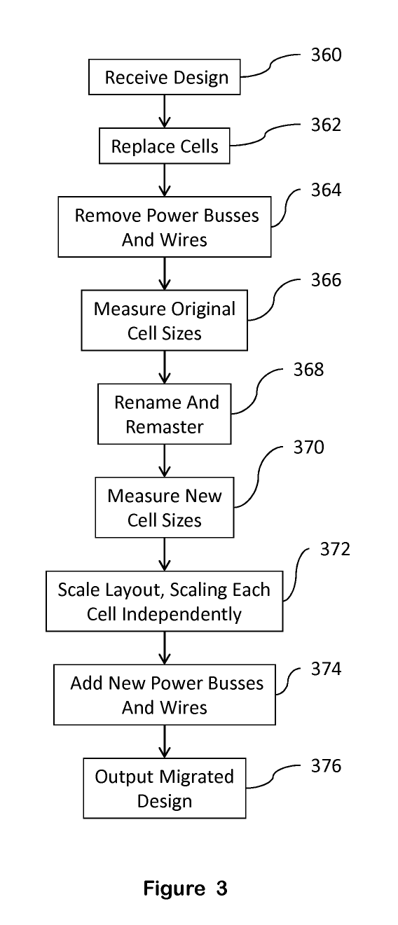

As shown in flowchart form in FIG. 3, various embodiments herein receive an original integrated circuit design associated with an original technology into a computerized device in item 360. The original integrated circuit design has an original design size and comprises a plurality of original cells. Also, each of the original cells comprises an individual grouping of integrated circuit devices performing a logical function.

In item 362, the methods herein automatically replace at least some of the original cells with replacement cells within the original integrated circuit design to migrate the integrated circuit design to a different technology (using the computerized device). The replacement cells have corresponding logical functions to the original cells that the replacement cells replace. Further, each of the replacement cells has an initial cell size that is unassociated with any specific design size. In item 364, the methods herein automatically remove power busses and wires from the original integrated circuit design and then, in item 366 measures original cell sizes. The cells are then renamed and remastered in item 368.

The methods herein further automatically measure new cell sizes in item 370 and change the scale layout, scaling each cell independently in item 372. The changing of the initial cell size of each of the replacement cells is performed individually for each of the replacement cells and can comprise an analog reduction process. The changing of the initial cell size of each of the replacement cells keeps vertically abutting cells aligned. The method can also change the orientation and/or origin of the replacement cells while changing the initial cell size of the replacement cells.

The methods herein automatically add new power busses and wires to the migrated integrated circuit design after changing the initial cell size of each of the replacement cells in item 374, and automatically output the migrated circuit design from the computerized device in item 376.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or D-2 block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

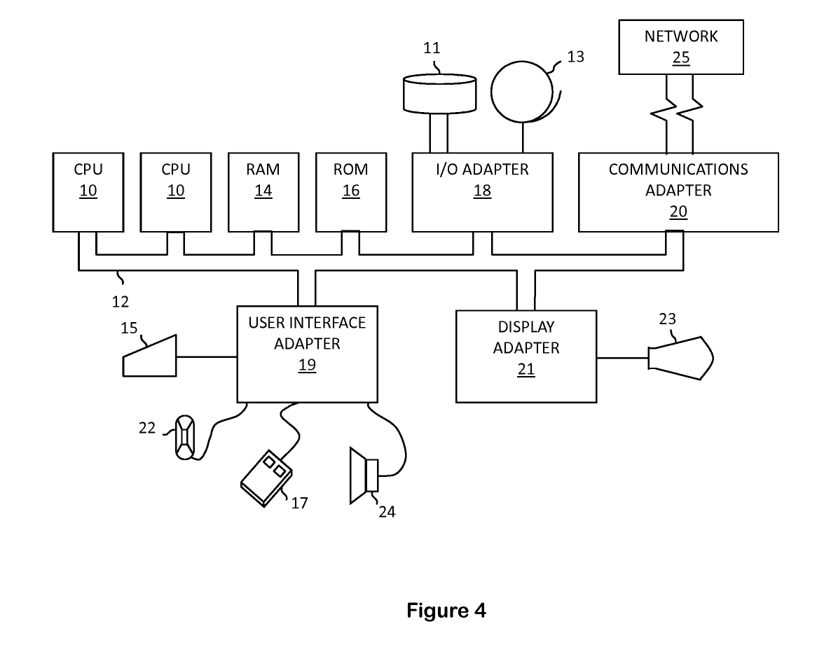

A representative hardware environment for practicing the embodiments of the invention is depicted in FIG. 4. This schematic drawing illustrates a hardware configuration of an information handling/computer system in accordance with the embodiments of the invention. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Deployment Types include loading directly in the client, server and proxy computers via loading a storage medium such as a CD, DVD, etc. The process software may also be automatically or semi-automatically deployed into a computer system by sending the process software to a central server or a group of central servers. The process software is then downloaded into the client computers that will execute the process software. The process software is sent directly to the client system via e-mail. The process software is then either detached to a directory or loaded into a directory by a button on the e-mail that executes a program that detaches the process software into a directory. Send the process software directly to a directory on the client computer hard drive. When there are proxy servers, the process will, select the proxy server code, determine on which computers to place the proxy servers' code, transmit the proxy server code, then install the proxy server code on the proxy computer. The process software will be transmitted to the proxy server then stored on the proxy server.

While it is understood that the process software may be deployed by manually loading directly in the client, server and proxy computers via loading a storage medium such as a CD, DVD, etc., the process software may also be automatically or semi-automatically deployed into a computer system by sending the process software to a central server or a group of central servers. The process software is then downloaded into the client computers that will execute the process software. Alternatively the process software is sent directly to the client system via e-mail. The process software is then either detached to a directory or loaded into a directory by a button on the e-mail that executes a program that detaches the process software into a directory. Another alternative is to send the process software directly to a directory on the client computer hard drive. When there are proxy servers, the process will, select the proxy server code, determine on which computers to place the proxy servers' code, transmit the proxy server code, then install the proxy server code on the proxy computer. The process software will be transmitted to the proxy server then stored on the proxy server.

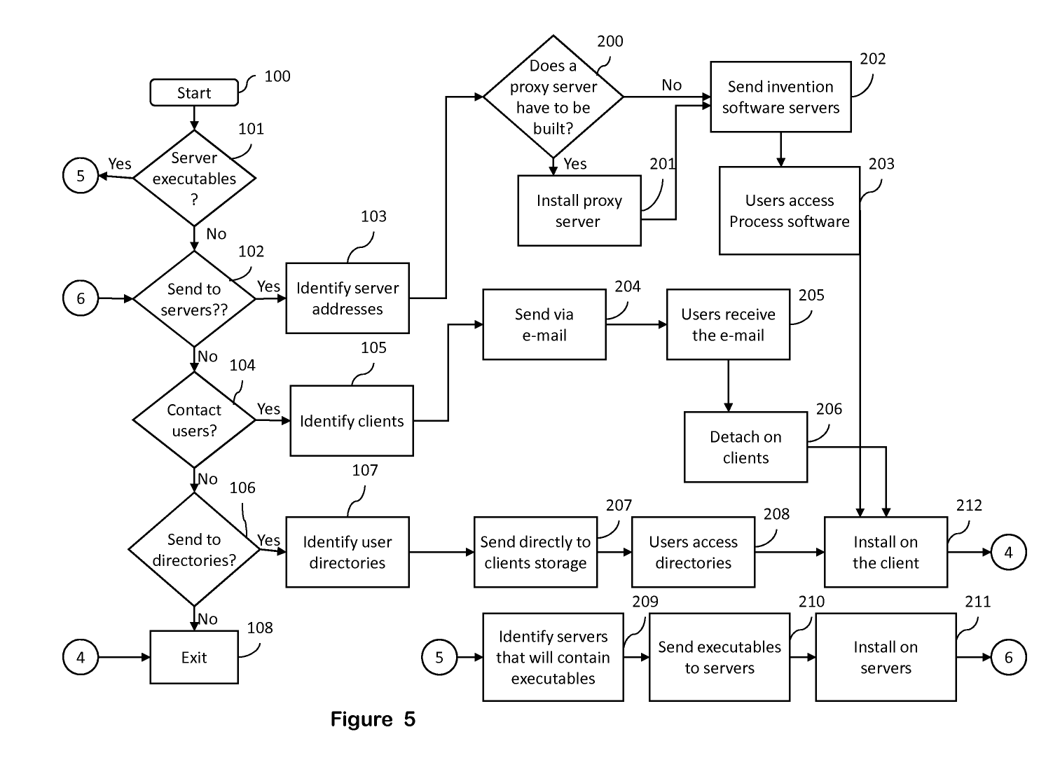

As shown in FIG. 5, Step 100 begins the deployment of the process software. The first thing is to determine if there are any programs that will reside on a server or servers when the process software is executed 101. If this is the case, then the servers that will contain the executables are identified 209. The process software for the server or servers is transferred directly to the servers' storage via FTP or some other protocol or by copying though the use of a shared file system 210. The process software is then installed on the servers 211.

Next, a determination is made on whether the process software is be deployed by having users access the process software on a server or servers 102. If the users are to access the process software on servers then the server addresses that will store the process software are identified 103.

A determination is made if a proxy server is to be built 200 to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required then the proxy server is installed 201. The process software is sent to the servers either via a protocol such as FTP or it is copied directly from the source files to the server files via file sharing 202. Another embodiment would be to send a transaction to the servers that contained the process software and have the server process the transaction, then receive and copy the process software to the server's file system. Once the process software is stored at the servers, the users via their client computers, then access the process software on the servers and copy to their client computers file systems 203. Another embodiment is to have the servers automatically copy the process software to each client and then run the installation program for the process software at each client computer. The user executes the program that installs the process software on his client computer 212 then exits the process 108.

In step 104, a determination is made whether the process software is to be deployed by sending the process software to users via e-mail. The set of users where the process software will be deployed are identified together with the addresses of the user client computers 105. The process software is sent via e-mail 204 to each of the users' client computers. The users then receive the e-mail 205, and then detach the process software from the e-mail to a directory on their client computers 206. The user executes the program that installs the process software on his client computer 212 then exits the process 108.

Lastly, a determination is made on whether to the process software will be sent directly to user directories on their client computers 106. If so, the user directories are identified 107. The process software is transferred directly to the user's client computer directory 207. This can be done in several ways such as but not limited to sharing of the file system directories and then copying from the sender's file system to the recipient user's file system or alternatively using a transfer protocol such as File Transfer Protocol (FTP). The users access the directories on their client file systems in preparation for installing the process software 208. The user executes the program that installs the process software on his client computer 212 then exits the process 108.

The process software which consists of is integrated into a client, server and network environment by providing for the process software to coexist with applications, operating systems and network operating systems software and then installing the process software on the clients and servers in the environment where the process software will function.

The first step is to identify any software on the clients and servers including the network operating system where the process software will be deployed that are required by the process software or that work in conjunction with the process software. This includes the network operating system that is software that enhances a basic operating system by adding networking features.

Next, the software applications and version numbers will be identified and compared to the list of software applications and version numbers that have been tested to work with the process software. Those software applications that are missing or that do not match the correct version will be upgraded with the correct version numbers. Program instructions that pass parameters from the process software to the software applications will be checked to ensure the parameter lists matches the parameter lists required by the process software. Conversely parameters passed by the software applications to the process software will be checked to ensure the parameters match the parameters required by the process software. The client and server operating systems including the network operating systems will be identified and compared to the list of operating systems, version numbers and network software that have been tested to work with the process software. Those operating systems, version numbers and network software that do not match the list of tested operating systems and version numbers will be upgraded on the clients and servers to the required level.

After ensuring that the software, where the process software is to be deployed, is at the correct version level that has been tested to work with the process software, the integration is completed by installing the process software on the clients and servers.

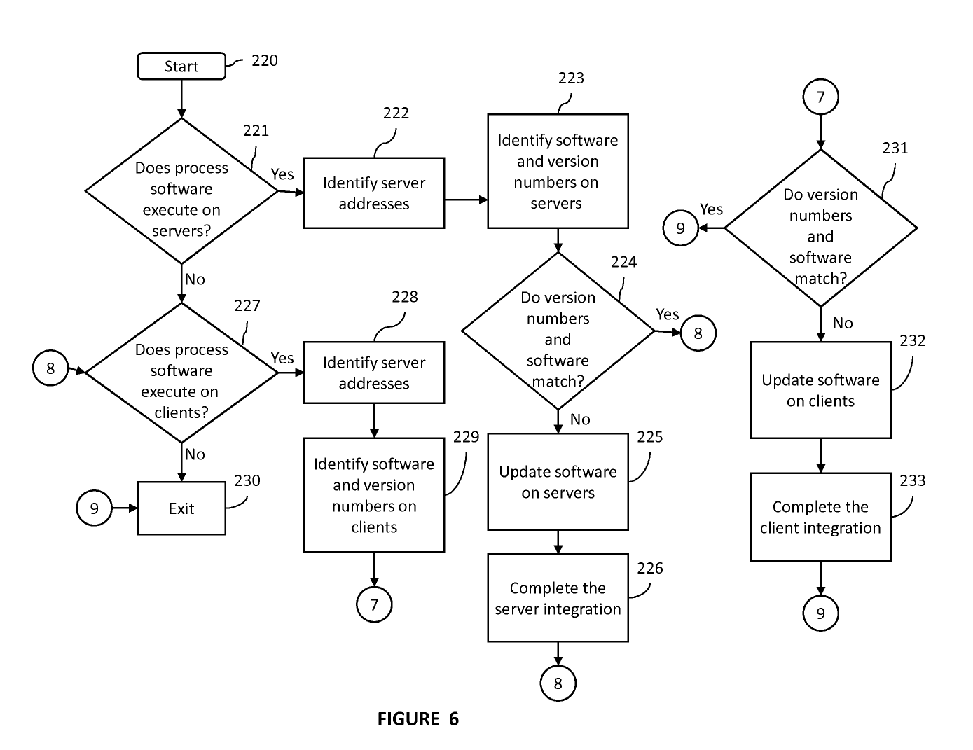

Referring to “Integration” Drawing FIG. 6 Step 220 begins the integration of the process software. The first thing is to determine if there are any process software programs that will execute on a server or servers 221. If this is not the case, then integration proceeds to 227. If this is the case, then the server addresses are identified 222. The servers are checked to see if they contain software that includes the operating system (OS), applications, and network operating systems (NOS), together with their version numbers, that have been tested with the process software 223. The servers are also checked to determine if there is any missing software that is required by the process software 223.

A determination is made if the version numbers match the version numbers of OS, applications and NOS that have been tested with the process software 224. If all of the versions match and there is no missing required software the integration continues in 227.

If one or more of the version numbers do not match, then the unmatched versions are updated on the server or servers with the correct versions 225. Additionally if there is missing required software, then it is updated on the server or servers 225. The server integration is completed by installing the process software 226.

Step 227 which follows either 221, 224 or 226 determines if there are any programs of the process software that will execute on the clients. If no process software programs execute on the clients the integration proceeds to 230 and exits. If this not the case, then the client addresses are identified 228.

The clients are checked to see if they contain software that includes the operating system (OS), applications, and network operating systems (NOS), together with their version numbers, that have been tested with the process software 229. The clients are also checked to determine if there is any missing software that is required by the process software 229.

A determination is made as to whether the version numbers match the version numbers of OS, applications and NOS that have been tested with the process software 231. If all of the versions match and there is no missing required software, then the integration proceeds to 230 and exits.

If one or more of the version numbers do not match, then the unmatched versions are updated on the clients with the correct versions 232. In addition, if there is missing required software then it is updated on the clients 232. The client integration is completed by installing the process software on the clients 233. The integration proceeds to 230 and exits.

The process software can be stored on a shared file system accessible from one or more servers. The process software is executed via transactions that contain data and server processing requests that use CPU units on the accessed server. CPU units are units of time such as minutes, seconds, hours on the central processor of the server. Additionally the assessed server may make requests of other servers that require CPU units. CPU units are an example that represents but one measurement of use. Other measurements of use include but are not limited to network bandwidth, memory usage, storage usage, packet transfers, complete transactions etc. When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to effect the performance of that server, other servers are accessed to increase the capacity and to share the workload. Likewise when other measurements of use such as network bandwidth, memory usage, storage usage, etc. approach a capacity so as to effect performance, additional network bandwidth, memory usage, storage etc. are added to share the workload. The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and or indicated on a web site accessed by the customer which then remits payment to the service provider. In another embodiment, the service provider requests payment directly from a customer account at a banking or financial institution. In another embodiment, if the service provider is also a customer of the customer that uses the process software application, the payment owed to the service provider is reconciled to the payment owed by the service provider to minimize the transfer of payments.

The process software is shared, simultaneously serving multiple customers in a flexible, automated fashion. It is standardized, requiring little customization and it is scalable, providing capacity on demand in a pay as-you-go model.

The process software can be stored on a shared file system accessible from one or more servers. The process software is executed via transactions that contain data and server processing requests that use CPU units on the accessed server. CPU units are units of time such as minutes, seconds, hours on the central processor of the server. Additionally the assessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to effect the performance of that server, other servers are accessed to increase the capacity and to share the workload. Likewise when other measurements of use such as network bandwidth, memory usage, storage usage, etc. approach a capacity so as to effect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and or indicated on a web site accessed by the customer which then remits payment to the service provider.

In another embodiment, the service provider requests payment directly from a customer account at a banking or financial institution.

In another embodiment, if the service provider is also a customer of the customer that uses the process software application, the payment owed to the service provider is reconciled to the payment owed by the service provider to minimize the transfer of payments.

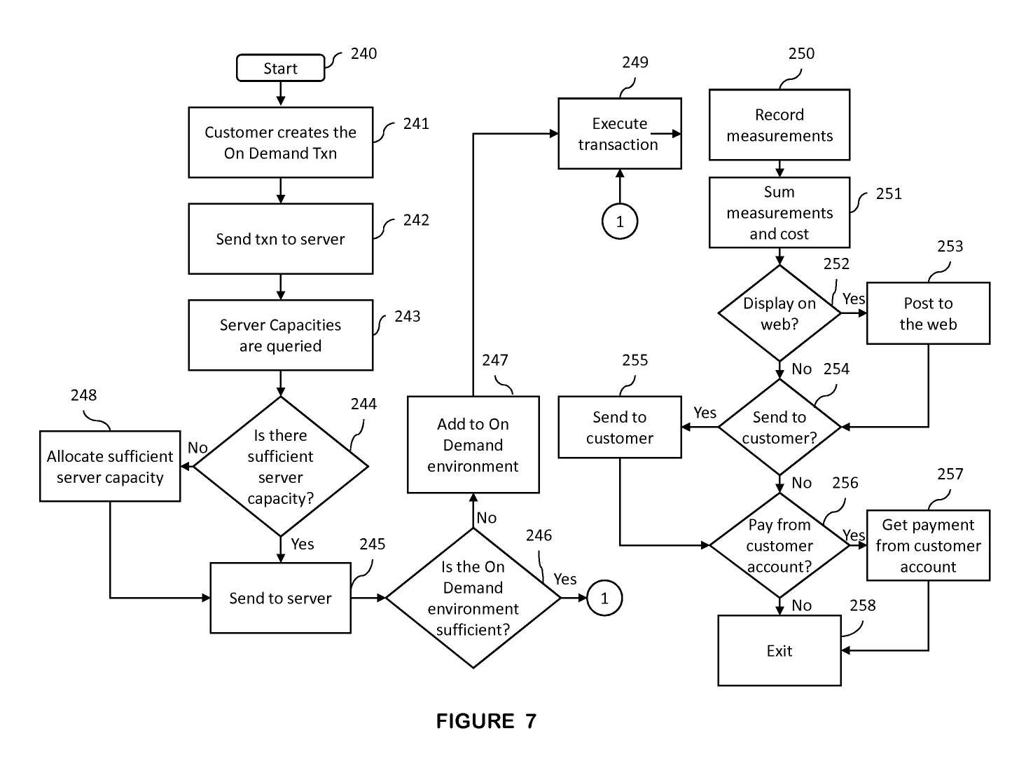

As shown in FIG. 7, Step 240 begins the On Demand process. A transaction is created than contains the unique customer identification, the requested service type and any service parameters that further specify the type of service 241. The transaction is then sent to the main server 242. In an On Demand environment the main server can initially be the only server, then as capacity is consumed other servers are added to the On Demand environment.

The server central processing unit (CPU) capacities in the On Demand environment are queried 243. The CPU requirement of the transaction is estimated, then the servers available CPU capacity in the On Demand environment are compared to the transaction CPU requirement to see if there is sufficient CPU available capacity in any server to process the transaction 244. If there is not sufficient server CPU available capacity, then additional server CPU capacity is allocated to process the transaction 248. If there was already sufficient Available CPU capacity, then the transaction is sent to a selected server 245.

Before executing the transaction, a check is made of the remaining On Demand environment to determine if the environment has sufficient available capacity for processing the transaction. This environment capacity consists of such things as but not limited to network bandwidth, processor memory, storage etc. 246. If there is not sufficient available capacity, then capacity will be added to the On Demand environment 247. Next the required software to process the transaction is accessed, loaded into memory, then the transaction is executed 249.

The usage measurements are recorded 250. The usage measurements consist of the portions of those functions in the On Demand environment that are used to process the transaction. The usage of such functions as, but not limited to, network bandwidth, processor memory, storage and CPU cycles are what is recorded. The usage measurements are summed, multiplied by unit costs and then recorded as a charge to the requesting customer 251. If the customer has requested that the On Demand costs be posted to a web site 252 then they are posted 253.

If the customer has requested that the On Demand costs be sent via e-mail to a customer address 254 then they are sent 255. If the customer has requested that the On Demand costs be paid directly from a customer account 256 then payment is received directly from the customer account 257. The last step is exit the On Demand process 258.

The process software may be deployed, accessed and executed through the use of a virtual private network (VPN), which is any combination of technologies that can be used to secure a connection through an otherwise unsecured or untrusted network. The use of VPNs is to improve security and for changed operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee.

The process software may be deployed, accessed and executed through either a remote-access or a site-to-site VPN. When using the remote-access VPNs the process software is deployed, accessed and executed via the secure, encrypted connections between a company's private network and remote users through a third-party service provider. The enterprise service provider (ESP) sets a network access server (NAS) and provides the remote users with desktop client software for their computers. The telecommuters can then dial a toll-free number or attach directly via a cable or DSL modem to reach the NAS and use their VPN client software to access the corporate network and to access, download and execute the process software.

When using the site-to-site VPN, the process software is deployed, accessed and executed through the use of dedicated equipment and large-scale encryption that are used to connect a companies multiple fixed sites over a public network such as the Internet.

The process software is transported over the VPN via tunneling which is the process of placing an entire packet within another packet and sending it over a network. The protocol of the outer packet is understood by the network and both points, called tunnel interfaces, where the packet enters and exits the network.

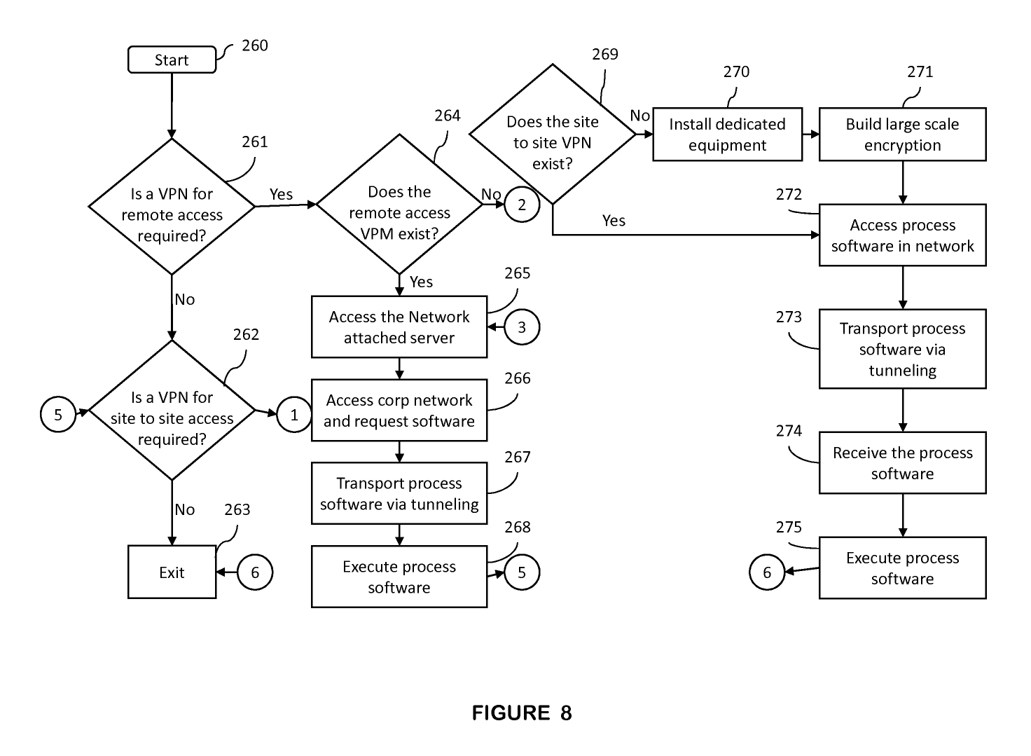

As shown in FIG. 8, Step 260 begins the Virtual Private Network (VPN) process. A determination is made to see if a VPN for remote access is required 261. If it is not required, then proceed to 262. If it is required, then determine if the remote access VPN exists 264. If it does exist, then proceed to 265.

After the remote access VPN has been built or if it been previously installed, the remote users can then access the process software by dialing into the NAS or attaching directly via a cable or DSL modem into the NAS 265. This allows entry into the corporate network where the process software is accessed 266. The process software is transported to the remote user's desktop over the network via tunneling. That is, the process software is divided into packets and each packet including the data and protocol is placed within another packet 267. When the process software arrives at the remote user's desktop, it is removed from the packets, reconstituted and then is executed on the remote users desktop 268.

A determination is made to see if a VPN for site to site access is required 262. If it is not required, then proceed to exit the process 263. Otherwise, determine if the site to site VPN exists 269. If it does exist, then proceed to 272. Otherwise, install the dedicated equipment required to establish a site to site VPN 270. Then build the large scale encryption into the VPN 271.

After the site to site VPN has been built or if it had been previously established, the users access the process software via the VPN 272. The process software is transported to the site users over the network via tunneling 273. That is, the process software is divided into packets and each packet including the data and protocol is placed within another packet 274. When the process software arrives at the remote user's desktop, it is removed from the packets, reconstituted and is executed on the site users desktop 275. Proceed to exit the process 263.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
receiving an original integrated circuit design into a computerized device, said original integrated circuit design having an original design size and comprising a plurality of original cells;
automatically replacing at least some of said original cells within said original integrated circuit design with replacement cells using said computerized device, each of said replacement cells having an initial cell size that is unassociated with any specific design size;
automatically changing said original design size of said integrated circuit design to a changed design size using said computerized device; and
automatically individually changing said initial cell size of each of said replacement cells to different sizes using said computerized device, such that at least two different replacement cells are changed from said initial cell size by different size reduction amounts based on different amounts of space required within said changed design size for each of said replacement cells.

2. The method according to claim 1, said changing of said initial cell size comprising an analog reduction process.

3. The method according to claim 1, said changing of said initial cell size of each of said replacement cells keeping vertically abutting cells aligned.

4. The method according to claim 1, said changing of said initial cell size of each of said replacement cells changing at least one of an orientation and an origin of said replacement cells while changing said initial cell size of said replacement cells.

5. The method according to claim 1, said changing of said initial cell size of each of said replacement cells being performed individually for each of said replacement cells being performed individually for each of said replacement cells.

6. The method according to claim 1, further comprising removing power busses and wires from said original integrated circuit design before changing said original design size of said integrated circuit design.

7. The method according to claim 6, further comprising adding new power busses and wires to said migrated integrated circuit design after changing said initial cell size of each of said replacement cells.

8. A method comprising:
receiving an original integrated circuit design associated with an original technology into a computerized device, said original integrated circuit design having an original design size and comprising a plurality of original cells, each of said original cells comprising an individual grouping of integrated circuit devices performing a logical function;
automatically replacing at least some of said original cells within said original integrated circuit design with replacement cells to migrate said integrated circuit design to a different technology using said computerized device, said replacement cells having corresponding logical functions to said original cells that said replacement cells replace, each of said replacement cells having an initial cell size that is unassociated with any specific design size;
automatically changing said original design size of said integrated circuit design to a changed design size using said computerized device;
automatically individually changing said initial cell size of each of said replacement cells to different sizes to produce a migrated circuit design using said computerized device, such that at least two different replacement cells are changed from said initial cell size by different size reduction amounts based on different amounts of space required within said changed design size for each of said replacement cells; and
automatically outputting said migrated circuit design from said computerized device.

9. The method according to claim 8, said changing of said initial cell size comprising an analog reduction process.

10. The method according to claim 8, said changing of said initial cell size of each of said replacement cells keeping vertically abutting cells aligned.

11. The method according to claim 8, said changing of said initial cell size of each of said replacement cells changing at least one of an orientation and an origin of said replacement cells while changing said initial cell size of said replacement cells.

12. The method according to claim 8, said changing of said initial cell size of each of said replacement cells being performed individually for each of said replacement cells being performed individually for each of said replacement cells.

13. The method according to claim 8, further comprising removing power busses and wires from said original integrated circuit design before changing said original design size of said integrated circuit design.

14. The method according to claim 13, further comprising adding new power busses and wires to said migrated integrated circuit design after changing said initial cell size of each of said replacement cells.

15. A computer storage device comprising a non-transitory, computer-readable storage medium storing instructions executable by a computer to perform a method comprising:
receiving an original integrated circuit design into a computerized device, said original integrated circuit design having an original design size and comprising a plurality of original cells;
automatically replacing at least some of said original cells with replacement cells within said original integrated circuit design using said computerized device, each of said replacement cells having an initial cell size that is unassociated with any specific design size;
automatically changing said original design size of said integrated circuit design to a changed design size using said computerized device; and
automatically individually changing said initial cell size of each of said replacement cells to different sizes using said computerized device, such that at least two different replacement cells are changed from said initial cell size by different size reduction amounts based on different amounts of space required within said changed design size for each of said replacement cells.

16. The computer storage device according to claim 15, said changing of said initial cell size comprising an analog reduction process.

17. The computer storage device according to claim 15, said changing of said initial cell size of each of said replacement cells keeping vertically abutting cells aligned.

18. The computer storage device according to claim 15, said changing of said initial cell size of each of said replacement cells changing at least one of an orientation and an origin of said replacement cells while changing said initial cell size of said replacement cells.

19. The computer storage device according to claim 15, said changing of said initial cell size of each of said replacement cells being performed individually for each of said replacement cells being performed individually for each of said replacement cells.

20. The computer storage device according to claim 15, said method further comprising:
removing power busses and wires from said original integrated circuit design before changing said original design size of said integrated circuit design; and
adding new power busses and wires to said migrated integrated circuit design after changing said initial cell size of each of said replacement cells.
